(19) United States
(12) Patent Application Publication
(10) Pub. No.: US 2005/0061612 A1
(43) Pub. Date: Mar. 24, 2005

(54) Production line

(76) Inventors: Burkhart Grob, Bad Worishofen (DE); Heinrich Lutz, Dirlewang (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/861,507

(22) Filed: Jun. 7, 2004

(30) Foreign Application Priority Data
Jun. 6, 2003 (DE) 103 25 878.7

(51) Int. Cl. B23Q 7/04

(52) U.S. Cl. 198/346.2

(57) ABSTRACT

The invention refers to a production line comprising at least two machine tools which machine work pieces. The work pieces are conveyed on a supply line from a conveying line to the machine tool. After machining the work pieces are conveyed by a removal line from the machine tool to a conveying line. Supply line and removal line are arranged in different levels one above the other.

The invention refers to a production line comprising at least two tool machines which machine work pieces, where the work pieces are conveyed on a supply line from the conveying line to the machine tool and are conveyed by a removal line from the machine tool to a conveying line.

### BACKGROUND OF THE INVENTION

Production lines as described in the beginning are known. With these production lines, for example, a supply line is arranged on the left hand side of the machine tool and the removal line on the right side. A finished work piece is therefore removed on another conveying line from the machine tool, without interfering with the supply of the next work piece.

It is a disadvantage with such a design that such an arrangement of supply and removal line needs a lot of space and also impedes the free access to the machine tool.

### BRIEF SUMMARY OF THE INVENTION

Coming from this state of the art the invention has the object to find an arrangement which is as space-saving as possible.

In order to solve this problem the invention comes from a production line as described in the beginning and suggests that the supply line and the removal line are arranged on different levels one above the other.

The invention achieves a considerable saving of space. Necessarily the machine tool has to be connected with the conveying line for conveying the work piece. However, if the removal line is arranged above or below the supply line, for the second conveying line no additional space is needed. Therefore the invention also achieves a very good access to the machine tool as only one region is blocked by the supply line, respectively the removal line, in contrast to the state of the art where two regions are blocked by the supply line, respectively the removal line. The proposal according to the invention, however, makes the further conveying of the machined parts considerably easier as also the conveying line, respectively the arrangement of the conveying line in the production line, can be made considerably simpler.

According to the invention on the supply line the raw part not yet machined is conveyed to the machine tool and on the removal line the machined part is conveyed away again. Therefore the work piece has to get from the supply line to the removal line. According to the invention several concepts are possible for that.

First of all it is suggested according to the invention that the machine tool has a movable work piece sledge for the work piece, and the movement of the work piece sledge is used for a conveying of the work piece from the level of the supply line to the level of the removal line. This work piece sledge, which can be shifted vertically, is provided in machine tools anyway in order to carry out, for example as Y-axis, a positioning of the work piece for machining purposes. However, if the work piece is conveyed in or out, usually the work piece sledge is not needed for machining purposes, it stands still. Usually the work piece sledge will be shifted then into the respective changing position anyway. The axis of movement of the work piece, present anyway, is used according to the suggestion of the invention, for example in order to bring the work piece into another level on the removal line.

In another variant of the invention it is provided that the production line has an elevator for the work piece which serves for conveying the work piece from the level of the supply line to the level of the removal line. Such a concept can be used, for example, when the work piece is conveyed out of the machine tool on the same level as it has come in. For example, the removal line in this variant is clearly longer than the supply line and projects beyond it until the out put spot on the machine tool from where the elevator conveys the removed work piece to the removal line. A similar arrangement is, of course, also possible vice versa, for example in such a way that the supply line is designed longer than the removal line. It is also possible to move either the raw part or the machined work piece before, respectively after machining, by the elevator. Of course, the elevator can be also arranged in the conveying line.

In another variant of the invention a translator unit is provided between the conveying line and the supply line and/or the removal line.

The translator unit causes the work piece to be translated from the conveying line to the angled connected supply line, respectively removal line. It is, for example, possible here that the translator unit is designed like an elevator, in particular if the conveying line is provided simultaneously for the supply line as well as for the removal line. Here also other variants are possible. It is, for example, provided that the conveying line is on the same level either with the supply line or the removal line, and a simple shifting of the work piece is sufficient to bring it from the conveying line to the conveying line on the same level. The work piece which is supported on the other supply line, located below or above it, would then have to be brought or taken by an elevator or a correspondingly movable translator unit to the conveying line.

The translator unit is, for example, designed like a robot and the robot arm puts the work piece on. Another possibility is to arrange the conveying line between the supply line and the removal line. Besides the translator units which have a certain mobility themselves, however, comparatively passive translator units are possible which are, for example, designed like ramps. The supply line is, for example, located below the conveying line and a work piece which has to be machined is segregated out of the stream on the conveying line, for example by means of stoppers, and put on a ramp on the supply line at the bottom. Vice versa it is possible to arrange the removal line above the level of the conveying line and to enclose a good through the ramp again in the stream of the conveying line.

The invention allows basically a parallel arrangement of supply line and removal line, of course, however, the invention comprises also a realisation of supply and removal line angled to each other, crossing each other or extending next to each other.

According to the invention it is provided that supply and removal line either interact with the very same conveying line or another variant according to the invention provides a first conveying line for the supply line and a second conveying line for the removal line.

In the case that a first and a second conveying line are provided it is convenient that these two conveying lines are also arranged one above the other, reducing the effort for shifting the work pieces considerably.

The invention is not restricted to the suggestion that only one conveying line is provided for the supply and removal line, the invention comprises in the same way also an arrangement where one conveying line is provided for the supply line and one is provided for the removal line. This suggestion may increase the effort for the realisation of the conveying line, however, the flow of material of work pieces through the multitude of machining tools becomes a little more structured by means of that and therefore also simpler in the operation, and the standstill period for the machining station for loading and unloading is reduced considerably.

According to the invention it is provided that the work piece is either moved directly on the conveying line, respectively the conveyors, or the work piece is mounted on a pallet and conveyed together with it.

In an advantageous embodiment of the invention it is provided that for conveying the work piece, respectively the pallet carrying the work piece, a device is provided and the device can move along the supply line, respectively the removal line. Accordingly, of course, individual devices are provided for the supply and the removal line, however, the supply and the removal line are designed for that similarly. This reduces the effort for realisation of such devices considerably. However, the invention does not exclude a variant where a device, the height of which can be adjusted, is provided for supply and removal line.

Alternatively it is possible to do without a particular device for conveying the work piece, respectively the pallet, and to design the conveyor as well as the conveying line, for example, as roller conveyor. However, the invention has other advantages, as it will be pointed out in the following.

First of all it is suggested according to the invention that the work piece, respectively the pallet carrying the work piece, is lifted from the first conveying line by the first device, respectively is deposited by the second device on the second conveying line.

The device has a task here similar to the one of the translator unit described before, it provides that the work piece is brought from the conveying line to the supply line, respectively from the removal line back to the conveying line. Additionally, however, the device also carries out a conveying of the work piece.

In another alternative embodiment of the invention it is provided that between the conveying line and the supply line, respectively the removal line, a line switch or a line crossing is arranged. Such an embodiment is possible with the variant where one conveying line is provided for supply and removal line or there is a first conveying line for the supply line and a second conveying line for the removal line. In this case the device does not provide necessarily that the work piece, respectively the pallet carrying the work piece, is picked up from the conveying line, respectively deposited on it. The device can be limited in this variant to picking up here the work piece which is supplied already on the supply line which just has been segregated via a line switch or a line crossing from the conveying line. The same goes naturally in the reversed case for the removal line.

This results in another advantage of the invention which is, however, even present generally. It is namely proposed that the work pieces are buffered on the supply and/or removal line, if necessary on the device. Another aim of the production line according to the invention is to achieve in particular a high machining performance, for example a high cutting performance of the machine tools. Necessary time for changing work pieces has to be reduced therefore to an absolute minimum. If the work pieces which have to machined are stored as close as possible to the machine tool this aim is achieved as the conveying ways are as short as possible.

Buffering the work pieces which have to be machined on the supply line supports this aim optimally. Vice versa it may be an advantage to convey the finished work pieces in a quick sequence out of the machine tool, and to deposit them for the time being on the removal line, and to carry out the enclosing of the finished work pieces to the conveying line not before the machine tool, for example, is machining again, and, if necessary, to fill again simultaneously the supply line.

For buffering here the supply line, respectively the removal line, can be provided directly, however, even the device can be provided as the device serves for conveying the good anyway. Of course, buffering of the good can be deleted in order to keep the supply and removal line as short as possible if the necessary space is not available in the hall.

As it is provided according to the invention that the work piece may be located directly on the supply or removal line, it is suggested according to another variant of the invention that the work piece, respectively the pallet carrying the work piece, is lifted by the device from the supply line, respectively deposited by the device on the removal line. As already mentioned, independent devices are provided for the supply line, respectively the removal line.

A considerable, additional advantage of the invention is the fact that the device also provides that the work piece is loaded in the machine tool, respectively is unloaded. According to the invention it is provided that the device passes the work piece on in a clamping device of the machine tool, respectively removes the work piece out of a clamping device. Therefore the device performs a multitude of different functions. First of all it serves for removing the work piece from the conveying line in order to convey it via the removal line to the machine tool. If necessary the work piece is buffered on the supply line with the device. After that the device takes care of inserting the work piece in the clamping device of the machine tool.

Conveniently the clamping device is arranged, for example, on the work piece sledge moving the work piece.

For unloading the machine there are, of course, exactly the same advantages of the device provided in the region of the removal line. It carries out the same task as in the reversed, analogous sense.

In a preferred variant of the invention it is provided that the device has a gripping device for securely gripping the work piece, respectively the pallet carrying the work piece. The gripping device has, for example, a gripping drive which drives swivelling levers in such a way that they engage in a first position in gripping pockets or undercuts of the pallet or the work piece in a holding way, and are, in a second position, swivelled out of them and thus release the work piece, respectively the pallet. A gripping device of the kind mentioned before is described, for example, in the priority document, the German patent application 103 25 878.7 in detail, these descriptions are referred to here expressly. Furthermore the gripping device of the patent application “Loading System for a Machining Station”, which also refers to the priority mentioned above, is referred to in the full content. Cleverly the gripping device is provided for holding the pallet carrying the work piece or the work piece directly only on one side and thus to make the passing on into a clamping device accordingly easier.

In another variant according to the invention it is provided that the gripping device projects beyond the device in the direction of movement of the device. The device is, for example, designed as a running carriage on a guide and allows by means of that a movement on the conveyor. According to the suggestion of the invention the pallet, respectively the work piece, is held by the gripping device not below the device, respectively the running carriage, but it projects beyond the device forwards, so that during the approach of the device to the machining station the conveyor does not need to extend into the precious working area of the machine tool, but the work piece which has to be machined is held into the machine like an extended hand.

The invention allows conveying the work piece, respectively the pallet carrying the work piece, suspended and/or upright by the device. Basically the device can carry out the conveying of the work piece suspended as well as upright, increasing the flexibility of such an arrangement considerably. In particular the suspended conveying has advantages as the work piece is then also brought into the machine tool suspended and a suspended machining is advantageous for cutting machining for chip removal.

In another variant according to the invention it is provided that the orientation of the work piece between the supply and the removal line can vary. It is, for example, provided that a work piece conveyed standing upright or suspended on the supply line is conveyed away after the machine tool on the removal line suspended or standing upright or rotated around 90°. During the shifting of the work piece from the supply line to the removal line it is suggested to rotate the work piece. This may be an advantage, for example, in a corresponding course of machining steps. This is achieved by an A-axis, necessary anyway for machining, or B-axis or A-B-axis in the work piece sledge of the machine tool. An additional swivelling station in the production line is not necessary with such a design. The corresponding turning device, however, may be arranged, for example, in the elevator connecting the two conveyors.

According to the invention it is possible that the work piece is screwed or clamped on a pallet. The use of pallets allows having always the same standardised elements for conveying and clamping the pallet, independent from the design of the work piece. It is a disadvantage for the clamping of the work piece on a pallet that of course the pallet has a constructive height which reduces the available space in the working area of the machine tool. This means that the machine tool has to be constructed accordingly larger if even the pallet, which does not have to machined, has to be held additionally. Therefore it is provided in a variant to use the pallet only for conveying. The work piece is supported by the pallet only loosely, the pallet is parked on the supply line and the work piece is loaded into the machining station by means of the device.

However, the invention also provides that the gripping device seizes the work piece directly and passes it on to the clamping device in the machining station. According to the invention it is therefore possible to do without the use of a pallet. According to the invention it is also possible to use the pallet for an upright as well as a suspended conveying of the work piece.

In another embodiment of the invention it is suggested that two or more supply lines, respectively removal lines, are arranged parallel for each level and the machine tool machines at least two work pieces simultaneously. Such an arrangement is convenient, for example, with multiple spindle machine tools which are designed to machine a larger number of work pieces simultaneously. It is, for example, provided, to clamp two work pieces on one pallet and to load two such pallets simultaneously into the machine tool so that four work pieces have to be machined in one machining step. As often operations have to be carried out parallel it is convenient to carry out loading and unloading on both supply and removal lines simultaneously. Conveniently this also leads to the result that the machine tool has a common work piece sledge for two or more work pieces. However, the invention is not determined in that way as it basically also allows an individual simultaneous machining of work pieces where the work pieces then are conveniently clamped on individual work piece sledges.

Conveniently it is provided that supplying and/or removal of work pieces is carried out together or independently from each other. Eventually this depends on the question whether similar work pieces or different work pieces are machined in the production line according to the invention simultaneously in one machine tool.

In order to increase the performance, on the one hand, but also the readiness for use, on the other hand, it is provided that the machine tools are supplied redundantly in the production line. Therefore it is suggested according to the invention that several machine tools are provided for similar machining.

In a preferred variant of the invention it is provided that the second conveying line, which removes the finished work pieces machined by a first machine tool, is simultaneously the first conveying line of a second machine tool to which the work pieces are conveyed for machining. The result of the serial connection of several machine tools is the fact that the supply line is, for the time being, at the top in the first machine tool, and then, in the second machine tool, is on the bottom so that the work piece finished in the first machine tool is conveyed out by the removal line at the bottom. The flow of work pieces is therefore each time shifted so that the result through a serial connection of the machine tools is that the second conveying line, which removes the work pieces machined by the first machine tool, is at the same time the first conveying line of a second machine tool arranged behind the first machine tool.

It is another advantage of the invention that the device has a holding device interacting with the work piece, respectively the pallet, and which carries, if necessary, the gripping device, and the holding device can move in order to lift the work piece, respectively the pallet, from the conveying line or to deposit it there. In the same way the holding device can also serve for lifting the pallet, respectively the work piece, out of the clamping device or to put it down on it. For that purpose the holding device has conveniently a drive designed preferably as vertical drive and allows a height adjustment towards the device. By means of such a design putting in or depositing either on the conveying line or in the clamping device is made considerably easier, corresponding arrangements in this region are conveniently not necessary.

Alternatively, however, it is possible to lower either the conveying line or to lift the supply or removal line in order to get the same result. It is therefore suggested in another variant according to the invention to design the conveying line partially, in particular in the region of the supply line, respectively the removal line, in such a way that it can be lowered, respectively be lifted, and to pass on the work piece, respectively the pallet, to the device, respectively to pick it up from the device. Naturally an analogous effect can be achieved with the conveyor designed accordingly.

Besides the variant that the conveying line can be lowered in such a way that the work piece, respectively the pallet, is passed on directly to the device it is, according to another variant, possible, to design the conveying line partially, in particular in the region of the supply line, respectively the removal line, in such a way that it can be lowered, respectively lifted in order to pass on the work piece, respectively the pallet, to the supply line, respectively to pick it up from the removal line.

### BRIEF DESCRIPTION OF THE SEVERAL VIEWS OF THE DRAWINGS

In the drawings the invention is shown diagrammatically. In the drawing:

FIGS. 1, 2 a top view of a part of the production line according to the invention and

FIGS. 3 to 6 each a view of a different variant of a detail of the production line according to the invention.

### DETAILED DESCRIPTION OF THE PREFERRED EMBODIMENT

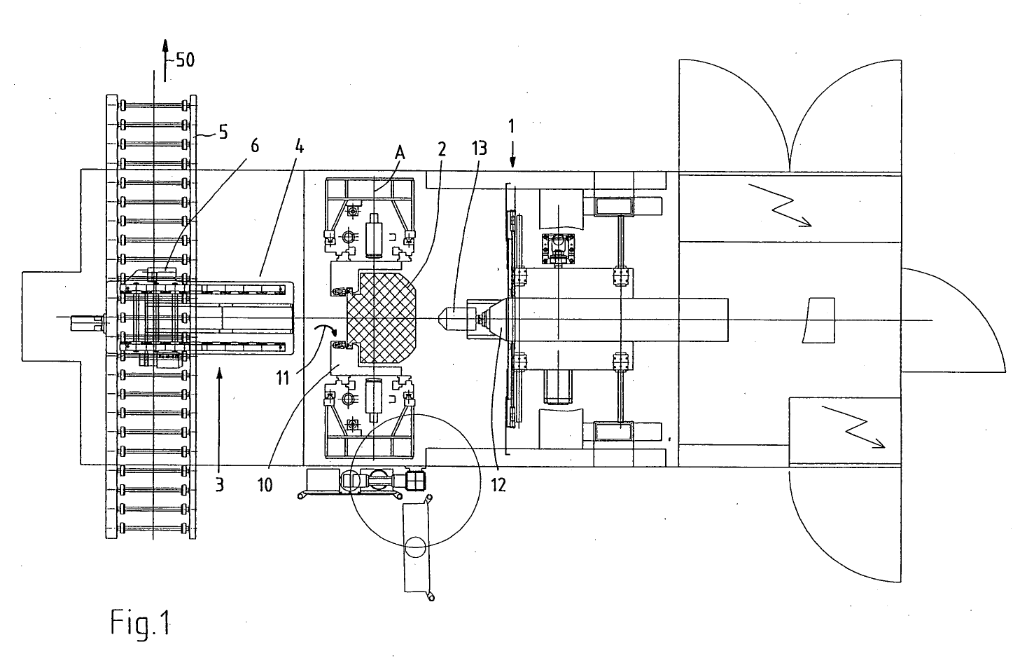

In FIG. 1 the production line according to the invention is shown schematically. The production line comprises at least two machine tools 1, however, in FIG. 1 only one of them is shown as a section of the production line according to the invention. The machine tool 1 serves for machining work pieces 2. As machining here for example cutting machining, but also every other kind of machining, may be provided. This includes in particular measuring or sizing stations, turning stations and so on, that is any machining for a work piece. However, it also makes sense to load and unload only one machine tool in this way with different pallets (work pieces).

The work pieces 2 are conveyed on a conveying line 5 from one machining station to the other. As shown in FIG. 1, the conveying line 5 runs from the bottom to the top, the main conveying direction 50 being indicated by the arrow pointing up. Other machining stations, following in the machining step, would be arranged in the direction of the arrow 50.

Production lines as mentioned above are used, for example, in transfer lines or complex assembly lines. By means of a multitude of machining stations arranged one behind the other therefore a very complex machining of work pieces becomes possible.

Rectangular connected to the conveying line 5 a supply line 3 as well as a removal line 4 is provided. As these two lines are arranged according to the invention one above the other only one of the conveyors 3, 4 can be seen from the top.

The work piece 2 is segregated from the conveying line 5 to the supply line 3 and conveyed in the machine tool 1 where a work piece 2 is shown already in the machining position clamped in the work piece sledge 10 by the clamping device 11.

In this embodiment for example a cutting machining is provided with the tool spindle 12 as machine tool 1. A machining tool 13 is arranged on the head of the tool spindle 12.

According to the invention it is provided that a conveying line 5 interacts with the supply line 3, respectively removal line 4, arranged at different levels.

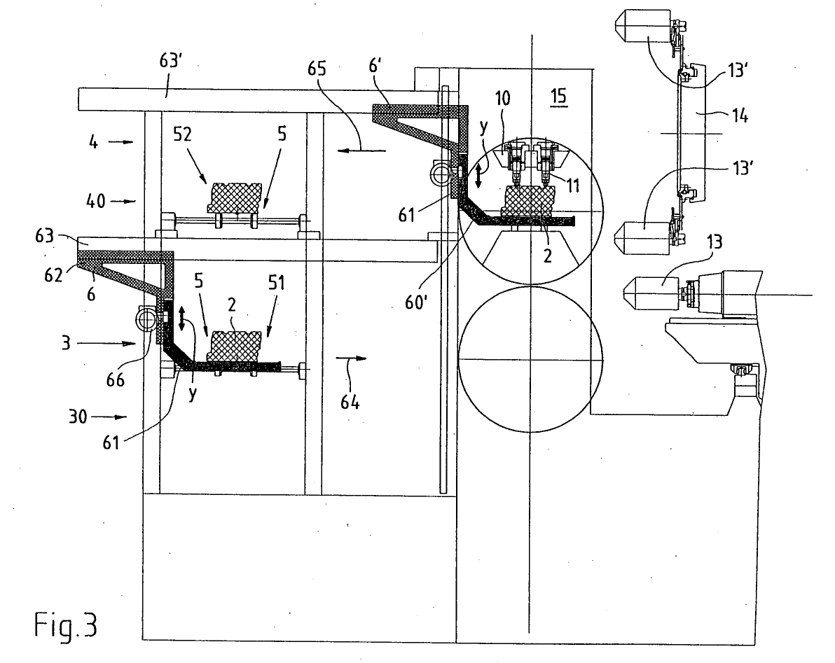

In contrast to that it is shown in FIG. 3 that according to the invention two conveying lines 51, 52 are provided. The first conveying line 51 is assigned here to the supply line 3, the second conveying line 52 to the removal line 4.

In this example it can be seen clearly that the level 40 of the removal line 4 is located above the level 30 of the supply line 3. Therefore the supply line 3 is underneath the removal line 4. However, it is also possible to realise a reversed arrangement.

The work piece 2 supplied on the first conveying line 51 is picked up in the example shown here in FIG. 3 by a device 6. The device 6 comprises a running carriage 62 which is guided on a guide or rail 63 orientated essentially horizontally. The support of the running carriage 62 in the rail 63 can be characterised as supply line, although the level 30 of the supply line is the level where the work piece 2 actually moves. In the example shown here it is a result that the supply line 3 is located above the level 30 of the supply line, this relation may also be vice versa.

In the position shown in FIG. 3 the first device 6 is retracted in such a way that it can be loaded with a work piece 2. The direction of movement of the work piece 2 then is to the right hand side, indicated by the arrow 64 into the working area of the machining tool 1.

In the example shown in FIG. 3 in the working area of the machine tool 1 a tool magazine 14 is provided which stores a number of machining tools 13′.

The example shown in FIG. 3 shows a work piece 2 standing on the device 6, in this example the use of a pallet not being necessary. Accordingly larger work pieces 2 can be machined in the machine tool 1. The work piece sledge 10 can move in Y-direction. The clamping device 11 arranged on the work piece sledge 10 seizes the work piece 2 from above in the example shown here. The position shown in FIG. 3 corresponds with the position where the already finished work piece 2 is conveyed out of the machine tool 1.

Also the removal line 4 has a device 6′ for conveying the finished work piece 2. In the example shown here the gripping device 60′ is introduced into the working area 15 and the fork-like gripping device 60 grips under the work piece 2 in order to convey it out of the machine tool 1.

In the example shown here the gripping device 60 is arranged on a holding device 61, the holding device 61 being movable in Y-direction, in order to be able, for example, to move the work piece 2 towards the sledge 10. This mobility of the holding device 61, however, is used in particular for depositing the work piece 2 on the conveying line 5 or to pick it up from it.

After the device 6′ has picked up the work piece 2 out of the machine tool 1 the device 6′ moves to the left hand side along the arrow 65. The rail 63, 63′ is provided in the example shown here extended to the left hand side, beyond the conveying line 5, 51, 52 elongated to the left hand side. This is necessary as the gripping device 60 of the device 6 projects on the right hand side in order to keep free the working area 15 of otherwise necessary conveying means of the removal line 4, respectively the supply line 3.

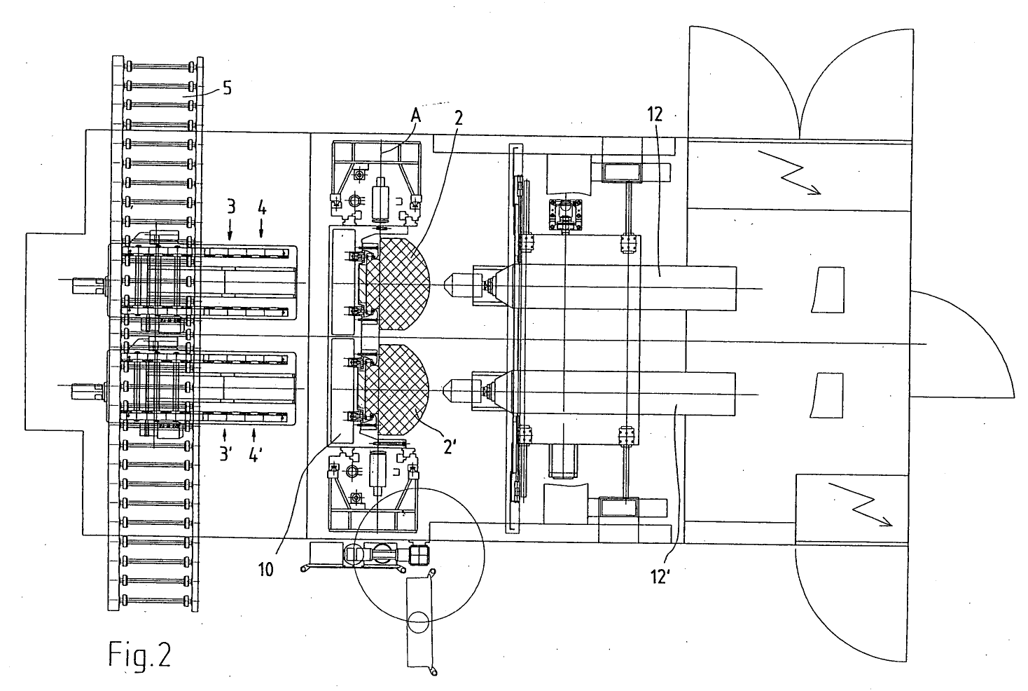

In the example shown in FIG. 2 a multiple spindle machine tool is shown. It has two tool spindles 12, 12′ which can act on two work pieces 2, 2′ either simultaneously or staggered from each other. There may also be more than two spindles. The work pieces 2, 2′ are arranged one beside the other and that is the reason why parallel supply lines 3, 3′ and removal lines 4, 4′ are provided in pairs. The machine tool has a common work piece sledge 10 for both work pieces 2, 2′, the work piece sledge can also rotate here around a horizontal axis A in order to allow a machining from several sides of the work pieces 2, 2′.

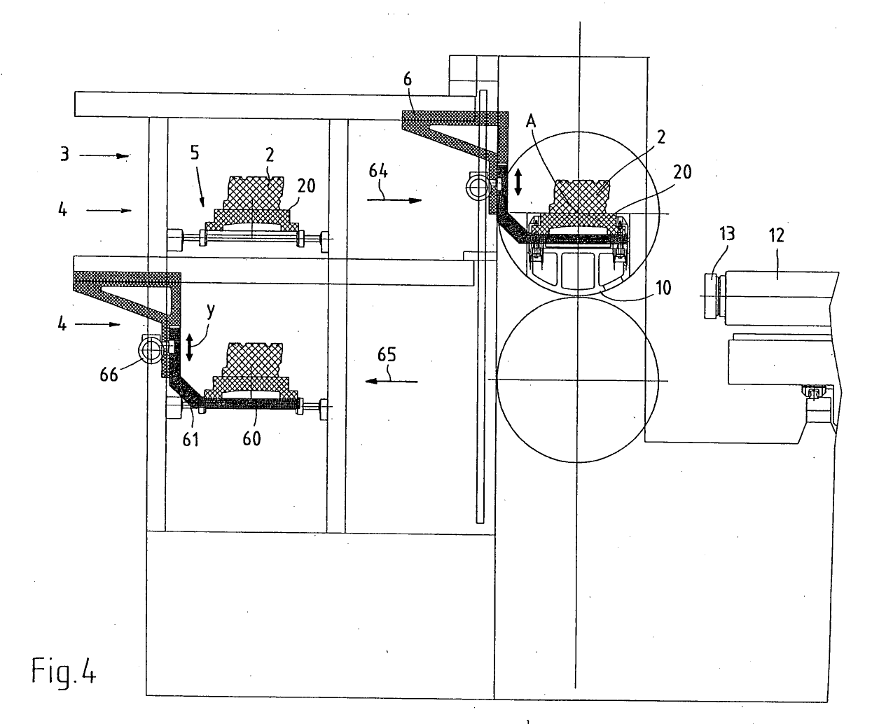

The situation shown in FIG. 4 is very similar to the one in FIG. 3. In the embodiment shown in FIG. 4 each work piece 2 is clamped on a pallet 20. The pallet 20 is supported on the roller conveyor of the conveying line 5, 51, 52. This means the work piece is conveyed upright. The upright conveying is also carried out as a consequence on the supply line 3, respectively the removal line 4. In contrast to the variant shown in FIG. 3 here, in FIG. 4, the supply line 3 is on the top and the removal line 4 is at the bottom. The example shown here has furthermore also a work piece sledge 10 which can rotate around the A-axis. It is also possible to rotate the work piece 2 around a vertical B-axis. So-called AB machines are also known which allow a rotation around A- and B-axis.

In the same way as in FIG. 3 also in FIG. 4 the holding device 61 can be shifted with regard to the running carriage 62 vertically (Y-axis), which is carried out by the drive 66.

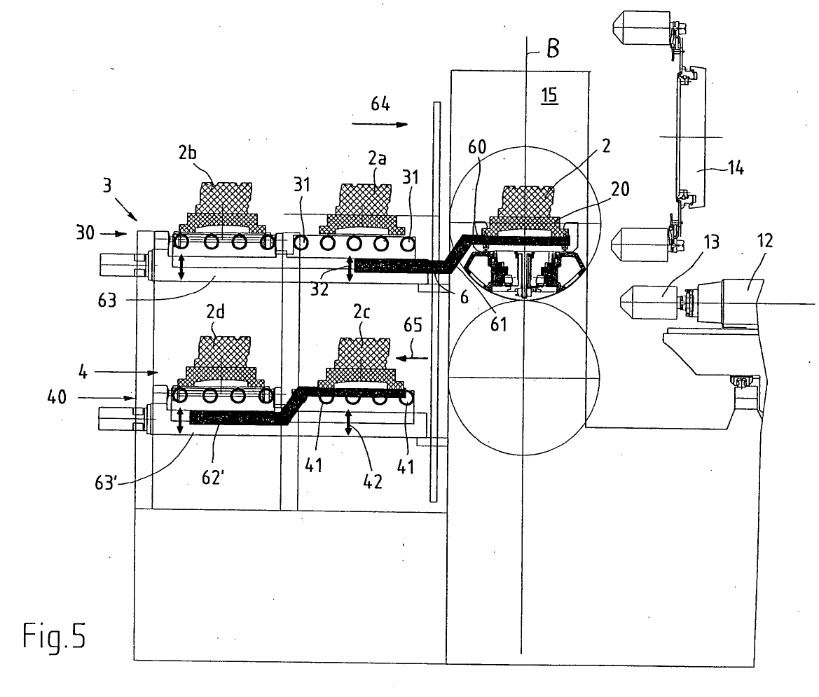

In FIG. 5 another variant according to the invention is shown. The device 6 again carries with its gripping device 60 a work piece 2 mounted on a pallet 20 upright in the working area 15. In contrast to the embodiment according to FIG. 4, where the holding device 61 is angled downward, in FIG. 5 the holding device 61 is angled upward in such a way that the levels 30, 40 are the supply lines 3, 4 above the respective guide rails 63, 63′. In the example shown here additionally transverse roller conveyors 31, 41 are provided in the supply line 3, respectively the removal line 4. These transverse roller conveyors 31, 41 belong to the supply line 3, respectively the removal line 4. It can be clearly discerned that on the top supply line 3 a first work piece 2 has already been conveyed in the working area 15, a second work piece 2a is ready in waiting position buffered in front of the working area 15, this work piece 2a being in waiting position on the transverse roller conveyor 31. The next work piece 2b but one is also already approached and is also in waiting position.

A similar situation is also given with the removal line 4. The work piece 2d is already again enclosed on the conveying line 5, here the second conveying line 52, and is conveyed away. For that purpose the work piece 2d is supported by the roller conveyor of the conveying line 5. The work piece 2c is still on the device 6′ which has just moved out of the working area 15 along the arrow 65. In the example shown here each of the transverse roller conveyors 31, 41 has a vertical adjustment possibility (indicated by arrows 32, 42), making picking up or depositing of the work piece 2 possible by lifting and lowering movement.

For example the transverse roller conveyor 31 is lifted up in order to lift thus the work piece 2a from the conveying line 5. As soon as the device 6 of the supply line 3 is moved back the transverse roller conveyor 31 can be lowered in such a way in order to put the work piece 2a on the space, which has now been vacated, on the gripping device 60.

In the region of the removal line 4 the transverse roller conveyor 41 is lifted in order to take the work piece 2, which has been conveyed out, away from the device 6′ which has been run out, and to enclose it again via the transverse roller conveyor 41 in the conveying line 52. There the work piece 2c will be deposited on the conveying line 52 by a lowering movement of the transverse roller conveyor.

Here also the gripping device 61 projects again with regard to the running carriages 62 on the device 6 in a level parallel to the level 30, 40. A buffering is carried out on the supply line 3 as well as on the removal line 4.

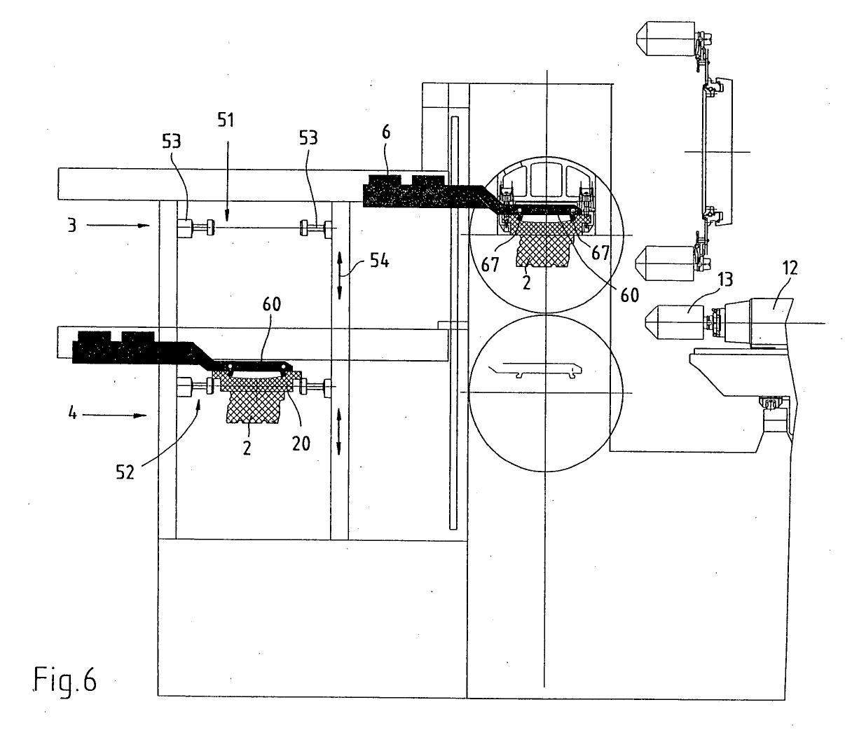

In FIG. 6 a suspended conveying of the work piece 2 on a pallet 20 is shown. The function of the gripping device 60 becomes here a bit more clearly as swivelling levers 67 engage discernibly in undercuts of the pallet 20 and hold it. The conveying line 5 here comprises two parallel extending rows 53 of rollers which form a free space between them. This goes for the first conveying line 51 as well as for the second conveying line 52. As the work piece 2 is suspended from the pallet 20, the work piece 2 fills the space between the two rows 53 of rollers. Vice versa at least the right hand sided row 53 of rollers interferes when the work piece 2 is being conveyed in the machine tool 1. For that purpose it is, for example, provided that the row 53 of rollers can be shifted vertically, which is indicated by the double arrow 54. Of course, the row 53 of rollers, if necessary even both rows of rollers, are not moved away before the pallet 20 has been picked up securely by the gripping device 60. Here again the arrangement one above the other of the supply line 3 and the removal line 4 can be seen clearly. The interfering row 53 of rollers also can be alternatively swivelled away around a vertical axis.

The claims filed with the application now and to be filed later are attempted formulations without prejudice for obtaining a broader protection.

If here, on closer examination, in particular also of the relevant prior art, it turns out that one or the other feature may be convenient for the aim of the invention, however, not decisively important, of course, already now a formulation is striven for which does not contain anymore such a feature, in particular in the main claim.

References in the sub-claims relate to the further design of the matter of the main claim through the characteristics of the respective sub-claim. These are, however, not to be understood as a waiver of independent protection of the matter for the characteristics of the referred sub-claims.

Characteristics only disclosed in the description now, may, in the course of proceedings, be claimed as being of inventive relevance, for example to distinguish from the state of the art.

Characteristics only disclosed in the description or even single characteristics from claims which comprise a variety of characteristics may be used at any time to distinguish from the state of the art in the first claim, and this is even if such characteristics may have been mentioned in connection with other characteristics, respectively achieve particular convenient results in connection with other characteristics.

Although the invention has been described by exact examples which are illustrated in the most extensive detail, it is pointed that this serves only for illustration and that the invention is not necessarily limited to it because alternative embodiments and methods become clear for experts in view of the disclosure. Accordingly changes can be considered which can be made without departing from the contents of the described invention.

1. Production line comprising at least two machine tools which machine work pieces, where the work pieces are conveyed on a supply line from a conveying line to the machine tool and are conveyed by a removal line from the machine tool to a conveying line, characterised in that supply and removal line (3, 4) are arranged on different levels (30, 40) one above the other.

2. Production line according to claim 1, characterised in that the machine tool has a movable work piece sledge (10) for the work piece (2), and the movement of the work piece sledge (10) serves for conveying the work piece (2) from the level (30) of the supply line (3) to the level (40) of the removal line (4).

3. Production line according to claim 1, characterised in that the production line has an elevator for the work piece which serves for conveying the work piece (2) from the level (30) of the supply line (3) to the level (40) of the removal line (4).

4. Production line according to claim 1, characterised in that a translator unit is provided between the conveying line (5) and the supply line (3) and/or the removal line (4).

5. Production line according to claim 1, characterised in that a first conveying line (51) is provided for the supply line (3) and a second conveying line (52) is provided for the removal line (4).

6. Production line according to claim 1, characterised in that a first conveying line (51) is provided for the supply line (3) and a second conveying line (52) is provided for the removal line (4), and the first and second conveying lines (51, 52) are arranged one above the other.

7. Production line according to claim 1, characterised in that for conveying the work piece (2), respectively for the pallet (20) carrying the work piece, a device (6) is provided, and the device (6) can move along the supply line, respectively the removal line (3, 4).

8. Production line according to claim 1, characterised in that for conveying the work piece (2), respectively the pallet (20) carrying the work piece, a device (6) is provided, and the device (6) can move along the supply line, respectively the removal line, (3, 4), and the work piece (2), respectively the pallet (20) carrying the work piece, is lifted by the first device (6) from the first conveying line (51), respectively is deposited by the second device (6′) on the second conveying line (52).

9. Production line according to claim 1, characterised in that between the conveying line (5) and the supply line, respectively the removal line, (3, 4) a line switch or line crossing is provided.

10. Production line according to claim 1, characterised in that the work pieces (2) are buffered on the supply and/or removal line (3, 4), if necessary on a device (6).

11. Production line according to claim 1, characterized in that for conveying the work piece (2), respectively the pallet (20) carrying the work piece, a device (6) is provided, and the device (6) can move along the supply line, respectively removal line, (3, 4), and the work piece (2), respectively the pallet (20) carrying the work piece, is lifted by the device (6) from the supply line (3), respectively is deposited by the device (6) on the removal line (4).

12. Production line according to claim 1, characterised in that for conveying the work piece (2), respectively the pallet (20) carrying the work piece, a device (6) is provided, and the device (6) can move along the supply line, respectively the removal line, (3, 4) and the device (6) passes the work piece (2) on into a clamping device (11) of the machine tool (1), respectively removes the work piece out of a clamping device (11).

13. Production line according to claim 1, characterised in that for conveying the work piece (2), respectively the pallet (20) carrying the work piece, a device (6) is provided, and the device (6) can move along the supply line, respectively removal line, (3, 4) and the device (6) has a gripping device (60) for securely gripping the work piece (2), respectively the pallet (20) carrying the work piece.

14. Production line according to claim 1, characterised in that for conveying the work piece (2), respectively the pallet (20) carrying the work piece, a device (6) is provided, and the device (6) can move along the supply line, respectively the removal line (3, 4), and the device (6) has a gripping device (60) for securely gripping the work piece (2), respectively the pallet (20) carrying the work piece, and the gripping device (60) projects in the direction of movement of the device (6) beyond the device.

15. Production line according to claim 1, characterised in that for conveying the work piece (2), respectively the pallet (20) carrying the work piece, a device (6) is provided, and the device (6) can move along the supply line, respectively the removal line, (3, 4), and the work piece (2), respectively the pallet (20) carrying the work piece, is conveyed by the device (6) suspended and/or standing up.

16. Production line according to claim 1, characterized in that a work piece (2), conveyed on the supply line (3) upright/suspended, is conveyed away after the machine tool (1) on the removal line (4) suspended/upright.

17. Production line according to claim 1, characterised in that the machine tool (1) has either a horizontal rotational axis (A) for the work piece (2), or a vertical rotational axis (B) or both rotational axes (AB).

18. Production line according to claim 1, characterized in that the work piece (2) is clamped on a pallet (20).

19. Production line according to claim 1, characterized in that for conveying the work piece (2), respectively the pallet (20) carrying the work piece, a device (6) is provided, and the device (6) can move along the supply line, respectively the removal line, (3, 4), and the device (6) has a gripping device (60) for securely gripping the work piece (2), respectively the pallet (20) carrying the work piece, and the gripping device (60) seizes in particular the suspended work piece (2) directly or the pallet (20) carrying the work piece.

20. Production line according to claim 1, characterized in that per level two or more supply lines, respectively removal lines, (3, 3′, 4, 4′) are arranged parallel and the machine tool (1) machines at least on two work pieces (2, 2′) at the same time.

21. Production line according to claim 1, characterised in that the machine tool (1) has for two or more work pieces (2, 2′) a common or for each one individual work piece sledge(s) (10).

22. Production line according to claim 1, characterised in that the supplying and/or the removal of work pieces (2, 2′) is carried out together or independently from each other.

23. Production line according to claim 1, characterised in that several machine tools (1) are provided for the same machining.

24. Production line according to claim 1, characterised in that the second conveying line which removes the work pieces machined on by a first machine tool is simultaneously the first conveying line of a second machine tool to which the work pieces are conveyed for machining.

25. Production line according to claim 1, characterised in that for conveying the work piece (2), respectively the pallet (20) carrying the work piece, a device (6) is provided and the device (6) can move along the supply line, respectively the removal line, (3, 4), and the device (6) has a holding device (61), which interacts with the work piece (2), respectively the pallet (20) carrying the work piece, if necessary carrying a gripping device (60), and the holding device (61) can move in such a way that it can lift the work piece, (2) respectively the pallet (20), from the conveying line (5) or the clamping device (11) or put it down on these.

26. Production line according to claim 1, characterised in that the conveying line (5) can be lowered, respectively lifted, partially in particular in the region of the supply line, respectively the removal line, (3, 4), in order to pass the work piece (2), respectively the pallet (20), to the supply line (3), respectively to pick it up from the removal line (4).

27. Production line according to claim 1, characterised in that for conveying the work piece (2), respectively the pallet (20) carrying the work piece, a device (6) is provided, and the device (6) can move along the supply line, respectively the removal line, (3, 4), and the conveying line (5) can be lowered, respectively lifted, partially, in particular in the region of the supply line, respectively the removal line (3, 4), in order to pass the work piece (2), respectively the pallet (20), on to the device (6), respectively to pick it up from the device (6).
